(19) United States
(12) Patent Application Publication
(10) Pub. No.: US 2011/0185294 A1
(43) Pub. Date: Jul. 28, 2011

(54) PATTERN-BASED USER INTERFACES

(75) Inventors: Joseph S. Binder, Seattle, WA (US); Stephen A. Weatherford, Kirkland, WA (US); Andy H. Kung, Seattle, WA (US); Richard Stanton, Redmond, WA (US)

(73) Assignee: Microsoft Corporation, Redmond, WA (US)

(21) Appl. No.: 12/691,744

(22) Filed: Jan. 22, 2010

(51) Int. Cl. G06F 3/048

(52) U.S. Cl. 715/762

(57) ABSTRACT

An intended usage of information to be displayed by a software application can be described. A selection of a user interface pattern module for displaying the information can be performed. The user interface pattern module can be designed for the intended usage. While running the application, user interface constructs for displaying the information using the user interface pattern module can be instantiated and organized, and can be rendered to display the information. Moreover, a first user interface pattern module can be selected and used with categorization metadata for the information to display the information in a first context, and a second user interface pattern module can be selected and used with the categorization metadata to display the information in a second context. Additionally, the categorization metadata may be revised, and the revised categorization metadata and a selected user interface pattern module may be used to instantiate and organize user interface constructs.

### BACKGROUND

Effective user interfaces typically employ proven user interface patterns to present information in a relevant, readable, and useful fashion. As used herein, a pattern is a visual pattern for presenting information. For example, each entry in a list of information may have multiple fields, with one of the fields being the main identifier for the information in the entry. A pattern may involve summarizing information in a list by including the main identifier at the top of each entry in the list. The main identifier may be presented with relatively large bold font, and the remainder of the information may be presented below the main identifier in regular non-bolded font. Other patterns can include patterns for entering bulk information, patterns for displaying detailed information, patterns for displaying information in a particular format (such as formats for dates, phone numbers, etc.). Best-practice visual design patterns are typically not formalized, but are implemented by developers who have knowledge of the patterns and guidelines for using them, as well as knowledge of user interface technologies.

### SUMMARY

The tools and techniques described herein can allow for easier and/or more efficient creation of effective user interfaces using patterns.

In one embodiment the tools and techniques can include describing an intended usage of information to be displayed by a software application. The application can be run, and a selection of a user interface pattern module for displaying the information can be performed. As used herein, a pattern module is declarative and/or computer-executable instructions that can be invoked to arrange and configure one or more user interface constructs to conform to a corresponding visual pattern, such as to a standard visual pattern for a particular use. The user interface pattern module can be designed for the intended usage. While running the application, user interface constructs for displaying the information using the user interface pattern module can be instantiated and organized, and the user interface constructs can be rendered to display the information.

In another embodiment of the tools and techniques, a categorization of information to be displayed with a software application can be performed to produce categorization metadata. A first user interface pattern module can be selected for displaying the information in a first context in the application, and a second user interface pattern module can be selected for displaying the information in a second context in the application. A first set of user interface constructs can be instantiated and organized to display at least a portion of the information using the first pattern module selection and the categorization metadata. The first set of constructs can be rendered to display the information in the first application context. A second set of user interface constructs can be instantiated and organized to display at least a portion of the information using the second pattern module selection and the categorization metadata. The second set of user interface constructs can be rendered to display the information in the second application context.

In yet another embodiment of the tools and techniques, a categorization of information to be displayed with a software application can be performed to produce categorization metadata, and the categorization metadata can be revised. The categorization metadata and a selection of a user interface pattern module for displaying the information can be used to instantiate and organize user interface constructs. The user interface constructs can be rendered to display the information.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a block diagram of a pattern-based user interface environment including a development environment and an application execution environment.

FIG. 3 is a block diagram of another pattern-based user interface environment including a development environment and an application execution environment.

FIG. 4 is a flowchart of a pattern-based user interface technique.

FIG. 5 is a flowchart of another pattern-based user interface technique.

FIG. 6 is a flowchart of yet another pattern-based user interface technique.

### DETAILED DESCRIPTION

Many developers do not have sufficient knowledge of user interface patterns and user interface technologies to effectively use patterns when developing software user interfaces. Moreover, even if a developer has such knowledge, creating user interfaces using the patterns can be time consuming. Embodiments described herein are directed to techniques and tools for easier and/or more efficient creation of effective pattern-based user interfaces. The embodiments may allow patterns to be used more efficiently by a larger group of developers than has been done with previous techniques. Such improvements may result from the use of various techniques and tools separately or in combination.

Such techniques and tools may include capturing metadata about information to be displayed with an application, describing an intended usage of the information to be displayed, and performing a categorization of the information using the metadata about the information. The categorization can produce categorization metadata. Performing the categorization can include performing one or more categorizations automatically and/or receiving user input that specifies one or more categorizations. A user interface pattern module for displaying the information can be selected. The user interface pattern module and the categorization metadata can be used to instantiate and organize one or more user interface constructs to display the information according to the categorization metadata and the pattern module. The metadata about the information to be displayed may also be used to instantiate and organize the user interface constructs according to that metadata. The user interface constructs can be rendered to display the information. Pattern module selection, as well as instantiating, organizing, and rendering the user interface constructs can be done while the application is running, such as in a computing environment that is different from a development environment where the intended usage is described. The pattern module selection may depend on dynamic information available when the application is running, such as whether an end user is authorized to edit a particular part of the information. The categorization metadata, the other information metadata, and/or the pattern module selection may be revised, and the revised categorization metadata, information metadata, and/or pattern module selection may be used in instantiating, organizing, and rendering the user interface constructs. In addition, the categorization metadata may be used with multiple different pattern modules to display the categorized information differently in different contexts in the application. Also, additional user interface pattern modules may be used within a main pattern module to form a series of nested user interface pattern modules, such as where a pattern module for an item is nested within a pattern module for an overall list of items.

Some “wizard”-type techniques have been used to describe data and emit boilerplate user interfaces for displaying the data according to patterns. However, such wizards have been limited. For example, typical wizard techniques have not allowed the instantiation and organization of user interface elements while the application is running. Those techniques also have not allowed revisions once the wizard has been run. In addition, those techniques have not allowed for using a data categorization to present the categorized information according to different pattern modules in different contexts.

Accordingly, one or more substantial benefits may be realized from the tools and techniques described herein. For example, pattern modules can be selected and user interface elements can be instantiated, organized, and rendered while the application is running, which can provide more flexibility in the pattern module selection and in the instantiation, organization, and rendering of user interface elements. Flexibility can also be enhanced by allowing revisions to the information metadata, categorization metadata, pattern modules, and/or pattern module selections, and by using metadata from a data categorization to present the information according to different pattern modules in different contexts. The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. For example, the various techniques described herein may be implemented with hardware or software, or a combination of both. Moreover, for the sake of simplicity, flowcharts may not show the various ways in which particular techniques can be used in conjunction with other techniques.

### I. Exemplary Computing Environment

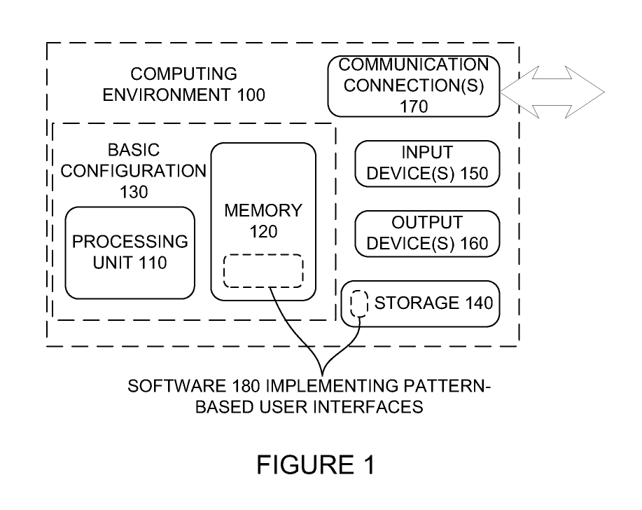

FIG. 1 illustrates a generalized example of a suitable computing environment (100) in which one or more of the described embodiments may be implemented. For example, one or more such computing environments can be used as a development environment or an application execution environment. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing pattern-based user interfaces.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of non-transitory computer-readable media. Computer-readable media are any available media that can be accessed within a computing environment. By way of example, and not limitation, with the computing environment (100), computer-readable media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Pattern-Based User Interface System and Environment

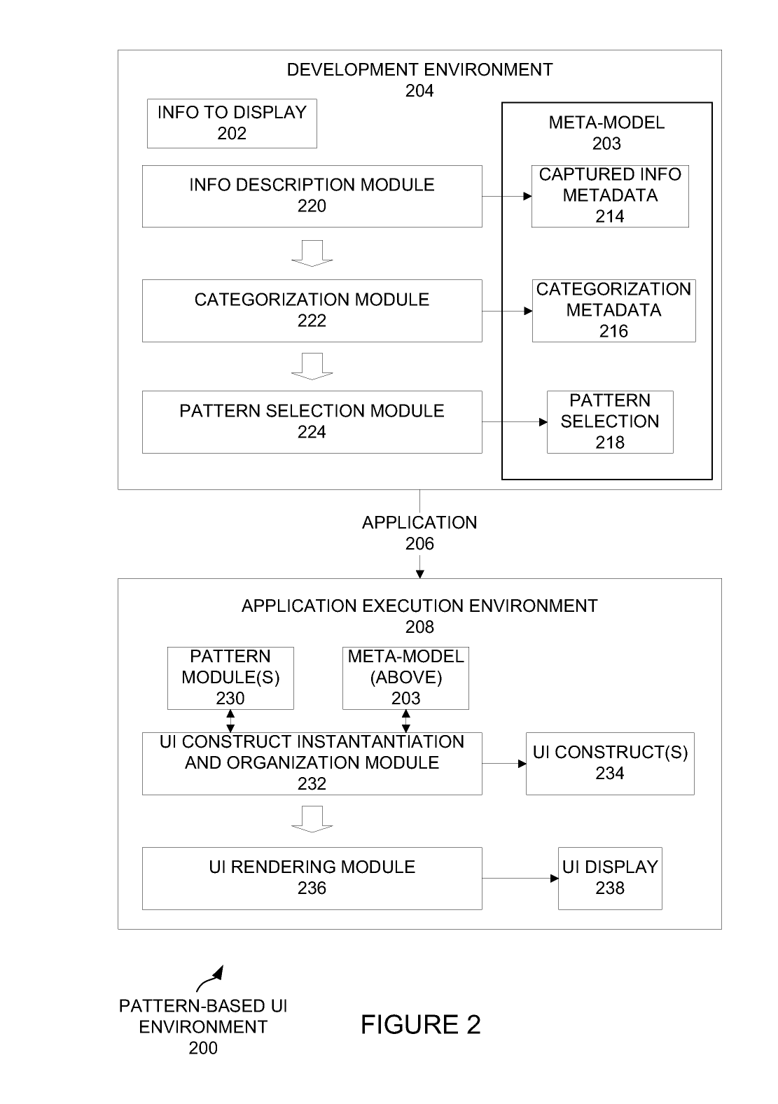

FIG. 2 is a block diagram of a pattern-based user interface computing environment (200) in conjunction with which one or more of the described embodiments may be implemented. The environment (200) can include information (202) to display, a meta-model (203) including metadata relating to the information (202), a development environment (204) for developing an application (206) that can display the information (202), and an application execution environment (208) that can run the application (206). The development environment (204) and the application execution environment (208) can be different environments, such as different physical or virtual machines. Each of these components of the pattern-based user interface environment (200) will be described in more detail below.

The information (202) to be displayed is illustrated in FIG. 2 in the development environment (204), but the information (202) can also be included with the application (206) in the execution environment (208). Moreover, some or all of the information (202) may not be present in the development environment (204). For example, at least a portion of the information (202) may be entered by a user while the application (206) is running in the execution environment (208). The information (202) may be any of various types of information. For example, the information may be data from a database, prompts for users to enter data, diagrams to be displayed, data entered by a user, etc.

The meta-model (203) can include captured information metadata (214), which can be in any of various formats, such as in an XML format. The information metadata (214) can describe the information (202) to be displayed. For example, the information metadata (214) may include field names or descriptions of fields in the information (202), types of fields in the information (202) (e.g., numeric, string, date and/or time). The information metadata (214) may also include related metadata (e.g., string-length constraints), which could affect user interface instantiation, organization, and/or rendering. The meta-model (203) can also include categorization metadata (216) of one or more aspects (e.g., fields, groups of fields, etc.) of the information (202).

In addition, the meta-model (203) can include a pattern selection (218), which may include an indication of an intended usage of at least a portion of the information (202). For example, the pattern selection (218) may include an indication that users will edit the information in bulk, which in turn indicates the selection of a user interface pattern module that allows bulk editing of the information. As another example, the pattern selection (218) may indicate that users desire a simple summary of the information, which can indicate the selection of a user interface pattern module that provides a simple summary.

The development environment (204) can be used to develop the application (206) to be run in the execution environment (208). As part of this development, the development environment (204) can capture the data for the meta-model (203). The data for the meta-model (203) (the information metadata (214), the categorization metadata (216), and/or the pattern selection (218)) can be captured in various ways, such as by receiving user input from a developer and/or inferring the data by running simple heuristics on a repository (e.g., a database, web service, etc.) for the information (202) to be displayed. In addition to the modules discussed below, the development environment can include other development modules such as those provided in Microsoft's Visual Studio® software development system.

The development environment (204) can include an information description module (220). The information description module (220) can capture the information metadata (214), which can describe the information (202) to be displayed. For example, the information metadata (214) can describe the structure and nature of the information to be displayed to an end-user. For example, the information metadata (214) may indicate that the information (202) to be displayed includes representations of customers, with each customer representation including a name, address, email, and phone number. The information metadata (214) can be captured by the information description module (220) in the development environment (204), and the information metadata (214) may also be persisted in the development environment (204).

The development environment (204) can also include a categorization module (222). The categorization module (222) can categorize the information (202) to be displayed, thereby producing categorization metadata (216). The categorization metadata (216) can include metadata that describes relative priority and semantics of the information (202). In the example of customer information discussed above, for example, the categorization metadata (216) can indicate that the name field is the primary identifier for the information, and that the email, address, and phone number fields are of secondary importance. The categorization module (222) can perform the categorization to produce categorization metadata (216) by receiving user input from a developer and/or by inferring the categorization information using simple heuristics on the information metadata (214) that is captured by the information description module (220). The categorization metadata (216) can be device and platform independent, so that it can be used in instantiating and organizing pattern-based user interfaces in any of various different platforms and/or devices, as will be discussed more below. The categorization can be performed (i.e., performed to produce categorization metadata (216)) in response to user input indicating one or more categorizations, and/or the categorization can be performed by automatically inferring the categorization metadata (216) from the information metadata (214). For example, if the information metadata (214) indicates that the name of a field is “name”, it may be inferred that the field is a primary identifier for at least a portion of the information (202).

The development environment (204) can also include a pattern selection module (224), which can instantiate and organize the pattern selection (218). The pattern selection (218) can include metadata describing how the information (202) is to be used, and/or what pattern or pattern module is to be used in displaying the information. For example, the pattern selection (218) may indicate that users will browse many instances of the information structure in a list, such as a list of customers. Alternatively, the pattern selection (218) may indicate other uses, such as by indicating that users will bulk-edit the information, that users will desire a detailed summary of the information, etc. The pattern selection (218) (which can include metadata indicating one or more selected pattern(s) or pattern module(s)) may be generated by responding to user input indicating the pattern selection (218). The pattern selection (218) may indicate that patterns or pattern modules are to be nested within each other. For example, one pattern may apply to each entry in a list, while another may apply to the overall list. A set of pattern modules may be available, so that the pattern selection (218) can choose from the available pattern modules. However, the set of pattern modules can be extensible so that additional patterns—and additional corresponding pattern modules to instantiate and organize user interface constructs according to the patterns—may be added, such as in response to user input by developers or others. The pattern selection (218) can include the selection of multiple pattern modules for the same information (202). For example, different pattern modules in the pattern selection (218) may apply in a different context in the application. For example, in one context the information (202) may not be editable, while in another context the information (202) may be editable. As another example, in one context the information (202) may be displayed in a summary pattern, and in another context the information (202) may be displayed in a detailed display pattern, with more of the details in the information (202) being displayed.

A developer may revise the meta-model (203), including making revisions to the information metadata (214), the categorization metadata (216), the pattern selection (218), and/or the selected pattern module itself. Also, if a second set of data in the meta-model (203) is inferred from a first set of data in the meta-model (203), then revisions to the first set can prompt revisions to the second set as well. For example, if the categorization metadata (216) is inferred from the information metadata (214), and the information metadata (214) is changed in a way that would affect the categorization metadata (216), the categorization metadata (216) can be updated to reflect the change.

Referring still to FIG. 2, the application (206) can be compiled in the development environment (204), and the compiled application can be passed to and run in the execution environment (208). The execution environment (208) can include available pattern modules (230), which can be run to implement patterns selected in the pattern selection (218). The execution environment (208) can include a user interface construct instantiation and organization module (232), which can use data from the meta-model (203) to instantiate and organize one or more user interface constructs (234). For example, the construct instantiation and organization module (232) can use the categorization metadata (216) and pattern selection (218) to instantiate and organize the user interface construct(s) (234) by invoking one or more of the pattern modules (230) corresponding to the pattern selection (218) to create one or more user interface constructs (234) to display the information in a manner that is optimized for a corresponding usage indicated in the pattern selection (218).

The invoked pattern module(s) (230) can apply the categorization metadata (216) to assign fields of the information (202) to categories in the pattern, and can instantiate and organize user interface construct(s) for displaying the information (202) with the assigned fields displayed according to pattern categories. For example, a “name” field of the information (202) may be categorized as a “primary identifier” in the categorization metadata (216). The pattern module (230) can have a “primary identifier” category, and the “name” field can be assigned to that category. As an example, the “primary identifier” category may appear at the top of the information in the user interface with a larger font size than other displayed information fields.

The user interface construct(s) (234) may include a platform and device independent layer of constructs, and a platform and/or device-dependent layer of constructs. This can allow a particular platform to be chosen from available platforms, and the platform-independent layer of constructs can be translated into the platform-dependent layer of constructs for the chosen platform. The platform-dependent layer of user interface constructs can include standard user interface constructs that can be used to invoke the selected platform or technology to render the constructs according to the selected pattern module. For example, the platform-dependent layer of user interface constructs can be in standard formats or special formats, such as HTML, Microsoft Silverlight™ format, Microsoft Word document format, XML, etc. As noted above, the pattern modules (230) can be extensible, so that additional pattern modules can be externally defined and made available in the development environment (204) and made available to applications developed in the development environment (204).

The execution environment (208) can also include a user interface rendering module (236) that can render the user interface construct(s) (234) to provide a user interface display (238). This may be done with a standard user interface platform or technology. For example, application programming interface calls can be made to the platform or technology. The platform or technology can respond by rendering the user interface construct(s) (234) to provide the user interface display (238) of the information (202) according to the meta-model (203). The captured information metadata (214) may also include platform-specific annotations (e.g., Silverlight™ or CSS style identifiers, or a theme definitions), which may be used in rendering the user interface.

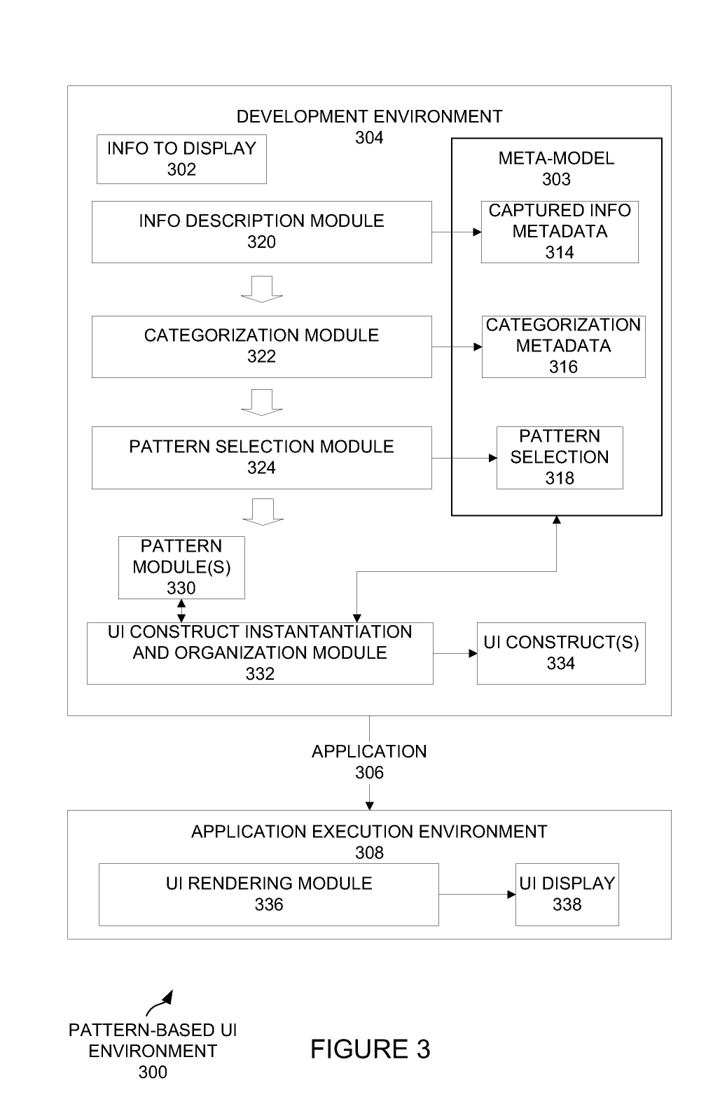

Referring now to FIG. 3, an alternative pattern-based user interface environment (300) will be discussed. The environment (300) can include the same components and component features as the environment (200) discussed above. Thus, the environment (300) can include information (302) to display in an application, a meta-model (303), a development environment (304), an application (306) developed in the development environment (304), an application execution environment (308), captured information metadata (314), categorization metadata (316), a pattern selection (318), an information description module (320), a categorization module (322), a pattern selection module (324), pattern module(s) (330), a user interface construct instantiation and organization module (332), user interface constructs (334), a user interface rendering module (336), and a user interface display (338). However, the user interface construct instantiation and organization module (332) can be in the development environment (304) instead of the execution environment (308), so that the user interface construct(s) are instantiated and organized in the development environment (304). Alternatively, there may be a user interface construct instantiation and organization module in the development environment, and another user interface construct instantiation and organization module in the execution environment, so that some user interface constructs can be instantiated and organized in the development environment and some user interface constructs can be instantiated and organized in the execution environment. The components of the pattern-based user interface environment may also be rearranged in other ways not explicitly detailed herein.

### III. Pattern-Based User Interface Techniques

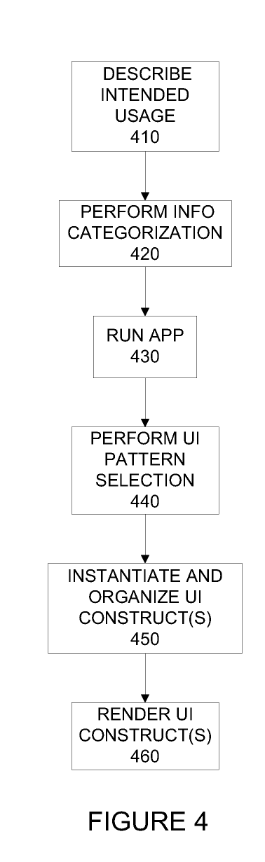

Referring to FIG. 4, a pattern-based user interface technique will be discussed. In a software development computing environment, an intended usage of information to be displayed by a software application can be described (410). A categorization of at least a portion of the information can be performed (420). The application can be run (430), and a selection of at least one user interface pattern module for displaying the information can be performed (440). While the application is running (430), one or more user interface constructs for displaying the information can be instantiated and organized (450) using the at least one user interface pattern module. Performance (420) of the categorization can produce categorization metadata that can be used in instantiating and organizing (450) the one or more user interface constructs. Also while the application is running (430), the one or more user interface constructs can be rendered (460) to display the information. Performance (440) of the pattern module selection may also be performed while the application is running (430), although it may be performed prior to running the application.

Describing (410) the intended usage of the information can include receiving user input indicating the intended usage. Instantiating and organizing (450) the one or more user interface constructs can include instantiating one or more platform independent user interface constructs and one or more platform dependent user interface constructs. Also, Instantiating and organizing (450) can account for application execution environment constraints. For example, instantiating and organizing (450) can include receiving user input selecting the platform, and at least a portion of the one or more user interface constructs can be formatted for the selected platform. As another example, styling can affect how user interface constructs are instantiated and organized. For example, a Microsoft Silverlight™ output platform can support styling and theming, so that different themes and/or styles can be applied. In one example, a printer-specific theme may be applied when instantiating and organizing user interface constructs for rendering a screen for printing. Thus, a user interface can behave and/or look different when rendering for printing than when rendering for screen display.

As another example, in an implementation for a mobile platform, the presentation of one or more user interfaces could be different due to the environment constraint of smaller screen sizes. For example, a pattern for a screen with different parts can be re-organized into a set of tabs to save screen space, or part of the screen can be placed behind a “more” button. Information about intended usage and categorization or other constraints can be accounted for along with this type of accounting for environment constraints. Continuing with the mobile platform example, information categorized as less important by metadata that represents a developer's intention may be placed into a “more” section of the screen automatically when user interface constructs are instantiated and organized. For example, it may be desirable to immediately display information labeled by a developer as “Title” and “Subtitle”, but it may not be as important to immediately display information labeled by a developer as “Description” information, so that the “Description” information can be placed into a “more” section of the screen.

Performance (420) of the categorization can include an assignment of one or more fields of the information into one or more categories in the at least one user interface pattern module. Also, performance (420) of the categorization may include performing one or more heuristics, such as heuristics on metadata related to the information to be displayed.

The technique of FIG. 4 may also include receiving user input indicating a revision of the categorization metadata, and revising the categorization metadata in response to the user input, to produce revised categorization metadata. The revised categorization metadata can be used in instantiating and organizing the one or more user interface constructs.

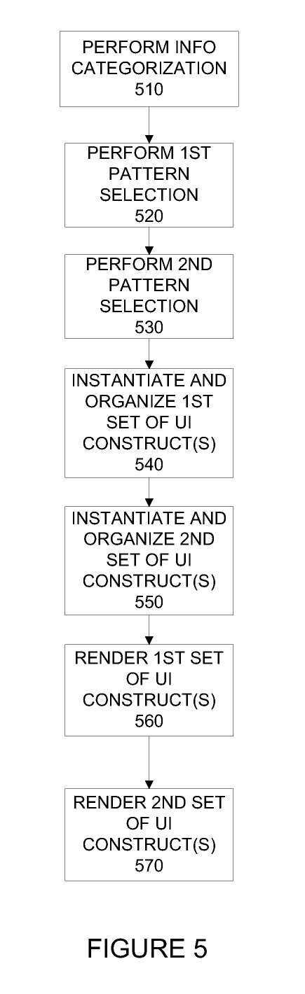

Referring now to FIG. 5, another pattern-based user interface technique will be discussed. The technique can include performing (510) a categorization of information to be displayed with a software application to produce categorization metadata. The technique can also include performing (520) a first selection of a first set of one or more user interface pattern modules for displaying the information in a first context in the application, as well as performing (530) a second selection of a second set of one or more user interface pattern modules for displaying the information in a second context in the application. A first set of one or more user interface constructs for displaying at least a portion of the information can be instantiated and organized (540) using the first pattern module selection and the categorization metadata, and a second set of one or more user interface constructs for displaying at least a portion of the information can be instantiated and organized (550) using the second pattern module selection and the categorization metadata. The first set of one or more user interface constructs can be rendered (560) to display the information in the first context, and the second set of one or more user interface constructs can be rendered (570) to display the information in the second context.

Rendering (560) the first set of one or more user interface constructs and rendering (570) the second set of one or more user interface constructs can be performed while the software application is running. Instantiating and organizing (540) the first set of one or more user interface constructs and instantiating and organizing (550) the second set of one or more user interface constructs can be performed while the application is running. Also, the technique can include describing a first intended usage of information in the first context and describing a second intended usage of the information in the second context. Describing the first intended usage of information in the first context and describing the second intended usage of the information in the second context can be performed in a computing environment that is different from a computing environment where rendering the first set of one or more user interface constructs and rendering the second set of one or more user interface constructs are performed.

The technique of FIG. 5 can also include capturing metadata describing the information, and at least a portion of the categorization can be performed by performing one or more heuristics on the metadata describing the information to be displayed.

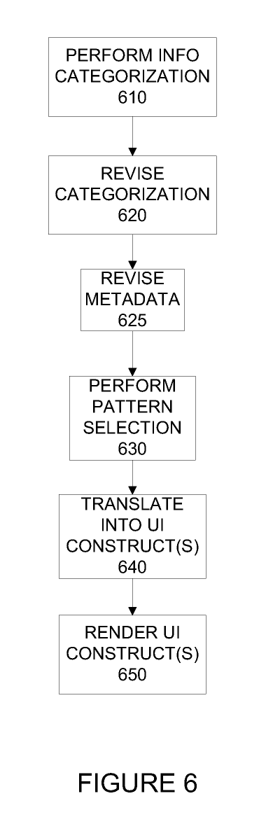

Referring now to FIG. 6, yet another pattern-based user interface technique will be discussed. The technique can include performing (610) a categorization of information to be displayed with a software application, producing categorization metadata. At least a portion of the categorization can be performed automatically. The categorization metadata can be revised (620), such as in response to user input indicating a revision to the categorization metadata, and other metadata describing the information to be displayed may also be revised (625). A selection of at least one user interface pattern module for displaying the information can be performed (630). The revised categorization metadata and the pattern module selection can be used to instantiate and organize (640) one or more user interface constructs. The one or more user interface constructs can be rendered (650) to display the information.

The technique of FIG. 6 can also include capturing metadata describing the information, and the metadata describing the information can be used in performing at least a portion of the categorization. If the metadata describing the information has been revised, the revised metadata may be used in performing at least a portion of the categorization. The technique can further include receiving user input indicating an intended usage of the information, and the at least one user interface pattern module can be designed for the intended usage.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A computer-implemented method, comprising:
in a software development computing environment, describing an intended usage of information to be displayed by a software application;
running the application;
performing a selection of at least one user interface pattern module for displaying the information, the at least one user interface pattern module being designed for the intended usage;
while running the application, instantiating and organizing one or more user interface constructs for displaying the information using the at least one user interface pattern module; and
while running the application, rendering the one or more user interface constructs to display the information.

2. The method of claim 1, wherein describing the intended usage of the information comprises receiving user input indicating the intended usage.

3. The method of claim 1, wherein instantiating and organizing the one or more user interface constructs comprises instantiating one or more platform independent user interface constructs and one or more platform dependent user interface constructs.

4. The method of claim 1, wherein instantiating and organizing the one or more user interface constructs accounts for one or more application execution environment constraints.

5. The method of claim 1, further comprising performing a categorization of at least a portion of the information, wherein performance of the categorization produces categorization metadata that is used in instantiating and organizing the one or more user interface constructs.

6. The method of claim 5, wherein performance of the categorization comprises an assignment of one or more fields of the information into one or more categories in the at least one user interface pattern module.

7. The method of claim 1, further comprising performing one or more heuristics to categorize at least a portion of the information, wherein the categorization produces categorization metadata that is used in instantiating and organizing the one or more user interface constructs.

8. The method of claim 1, wherein instantiating and organizing the one or more user interface constructs further comprises receiving user input selecting a platform, and wherein at least a portion of the one or more user interface constructs are formatted for the selected platform.

9. The method of claim 1, wherein:
selection of the at least one user interface pattern module is performed while running the application;
the method further comprises performing a categorization of at least a portion of the information, wherein the categorization produces categorization metadata;
the method further comprises receiving user input indicating a revision of the categorization metadata, and revising the categorization metadata in response to the user input to produce revised categorization metadata;
the revised categorization metadata is used in instantiating and organizing the one or more user interface constructs; and
the categorization metadata comprises an assignment of one or more fields of the information into one or more categories in the at least one user interface pattern module.

10. One or more computer-readable storage media having computer-executable instructions embodied thereon that, when executed by at least one processor, cause the at least one processor to perform acts comprising:
performing a categorization of information to be displayed with a software application to produce categorization metadata;
performing a first selection of a first set of one or more user interface pattern modules for displaying the information in a first context in the application;
performing a second selection of a second set of one or more user interface pattern modules for displaying the information in a second context in the application;
instantiating and organizing a first set of one or more user interface constructs for displaying at least a portion of the information using the first pattern module selection and the categorization metadata;
instantiating and organizing a second set of one or more user interface constructs to display at least a portion of the information using the second pattern module selection and the categorization metadata;
rendering the first set of one or more user interface constructs to display the information in the first context; and
rendering the second set of one or more user interface constructs to display the information in the second context.

11. The one or more computer-readable storage media of claim 10, wherein rendering the first set of one or more user interface constructs and rendering the second set of one or more user interface constructs are performed while the software application is running.

12. The one or more computer-readable storage media of claim 11, wherein instantiating and organizing the first set of one or more user interface constructs and instantiating and organizing the second set of one or more user interface constructs are performed while the application is running.

13. The one or more computer-readable storage media of claim 10, wherein the acts further comprise describing a first intended usage of information in the first context and describing a second intended usage of the information in the second context.

14. The one or more computer-readable storage media of claim 13, wherein describing the first intended usage of information in the first context and describing the second intended usage of the information in the second context are performed in a computing environment that is different from a computing environment where rendering the first set of one or more user interface constructs and rendering the second set of one or more user interface constructs are performed.

15. The one or more computer-readable storage media of claim 10, further comprising capturing metadata describing the information, wherein at least a portion of the categorization is performed by performing one or more heuristics on the metadata describing the information.

16. One or more computer-readable storage media having computer-executable instructions embodied thereon that, when executed by at least one processor, cause the at least one processor to perform acts comprising:
performing a categorization of information to be displayed with a software application to produce categorization metadata;
revising the categorization metadata;
performing a selection of at least one user interface pattern module for displaying the information;
instantiating and organizing one or more user interface constructs using the revised categorization metadata and the pattern module selection; and
rendering the one or more user interface constructs to display the information.

17. The one or more computer-readable storage media of claim 16, wherein the acts further comprise capturing metadata describing the information, and wherein the metadata describing the information is used in performing at least a portion of the categorization.

18. The one or more computer-readable storage media of claim 17, wherein the acts further comprise revising the metadata describing the information and using the revised metadata in performing at least a portion of the categorization.

19. The one or more computer-readable storage media of claim 16, wherein revising the categorization metadata comprises receiving user input indicating a revision to the categorization metadata.

20. The one or more computer-readable storage media of claim 16, wherein the acts further comprise receiving user input indicating an intended usage of the information, and wherein the at least one user interface pattern module is designed for the intended usage.
